(19) United States
(12) Patent Application Publication
(10) Pub. No.: US 2026/0127459 A1
(43) Pub. Date: May 7, 2026

(54) SYSTEM AND METHOD TO IMPROVE RESULTS OF AN ELECTRONIC SEARCH OF PREEXISTING ELECTRONIC OBJECTS

(71) Applicant: Primer Technologies, Inc., San Francisco, CA (US)

(72) Inventors: Oleg VASILYEV, Palo Alto, CA (US); Shelly SCHWARTZ, San Francisco, CA (US); John BOHANNON, San Francisco, CA (US)

(73) Assignee: Primer Technologies, Inc., San Francisco, CA (US)

(21) Appl. No.: 19/375,406

(22) Filed: Oct. 31, 2025

Related U.S. Application Data
(60) Provisional application No. 63/715,392, filed on Nov. 1, 2024.

(51) Int. Cl. G06N 5/04

(52) U.S. Cl. CPC G06N 5/04

(57) ABSTRACT

Embodiments described herein includes systems and methods for enhancing the outcomes of electronic searches targeting preexisting electronic objects, each previously segmented into data chunks and encoded into representative numeric vectors via a first embedder, with data stored in a knowledge base. The system includes a second embedder that translates queries into corresponding numeric vectors compatible with the first embedder's outputs. A search engine retrieves data records from the knowledge base by comparing similarity scores between query and object vectors. A processor introduces a bias to these vectors based on a calculated distance function, resulting in biased vectors that refine search results. An output device presents the processed search outcomes, optimizing relevance by leveraging biased vectors within a constrained data record set.

### CROSS-REFERENCE TO RELATED APPLICATION

This application claims the priority under 35 USC 119 to Provisional Patent Application No. 63/715,392 entitled “System And Method To Improve Results Of An Electronic Search Of Preexisting Electronic Objects” filed Nov. 1, 2024, the disclosure of which is hereby expressly incorporated by reference in its entirety.

### BACKGROUND

A plurality of sources has and continues to constantly generate images, articles, graphs, and other similar electronic objects that are used in providing information about one or more particular events or entities.

These plurality of sources include companies (e.g., annual reports, marketing materials, published reports, SEC filings, web content), governmental entities, institutions of higher education (e.g., academic articles), non-fiction books, private think tanks, news organizations (e.g., ABC, BBC, CBS, CNN, CSPAN, The Financial Times, FoxNews, NBC, The New York Times, Newsweek Magazine, NPR, PBS, The San Francisco Chronicle, The Wall Street Journal, The Washington Post), social media (e.g., Facebook, Instagram, TED Talks, TikTok, X), among other possible sources.

The events may include financial events, scientific finds, product introductions, world news events, and local news events, among other possible events.

The entities may include companies, countries, groups, organizations, and people, among other possible entities.

The electronic objects generated may include various facts, images, or other data that can be used in providing a reader or viewer with information about the particular event or entity. Different preexisting electronic objects may provide similar, even redundant information about a particular event or entity. Some electronic objects may provide different, even potentially incremental information about the particular event or entity. Electronic objects may be created by converting printed materials into electronically-readable form.

These electronic objects generated may be stored on one or more data servers accessible via one or more computer networks. These one or more computer networks may be private (i.e., accessible only to a select group of users) or public. Each of these computer networks may comprise one or more local area or wide area networks. One exemplary computer network may be the Internet. Another exemplary computer network may be the internal document database of a company, firm, or organization.

In view of the foregoing, the number of electronic objects available for consideration is immense and growing larger overtime. These electronic objects are preexisting in the sense that they are created before someone or some process accesses them for review or consideration.

For more than a decade, people have been using electronic search engines (such as Google® and Microsoft Bing®) to retrieve potentially relevant electronic objects from the plurality of sources across the Internet. Most often, text-based search queries (e.g., “current automobile recalls”) are fed into the interface of the electronic search engine using a keyboard or speech-to-text conversion utility.

Electronic search engines conduct searches in real-time or with indexes or some combination of these two approaches. “Indexing” generally refers to automatic pre-accessing, parsing, and storage of data representative of each electronic object encountered by a mechanism of the search engine. These search engine mechanisms that automatically pre-access and parse electronic objects are often referred to as “crawlers” because they automatically traverse all of the electronic objects stored on the various data servers accessible via the computer network associated with the electronic search engine. Where the computer network is the Internet, they are alternatively referred to as web crawlers.

Electronic search engines have a ranking or sorting algorithm that determines the arrangement and order of presentation of each of the potentially relevant electronic objects based on the relevancy (or similarity) of each electronic object to the search query. Depending upon the nature of the concept being searched, the electronic search engine may return pages upon pages of potentially relevant electronic objects. As one would expect, current ranking algorithms rank electronic objects with similar content similarly, as such the electronic objects that populate the first pages of the search results often contain largely similar (i.e. redundant) information.

Human users may solve for this redundancy problem by reviewing the electronic objects returned across the first handful of search result pages until the human is satisfied they have uncovered sufficient information or that human is frustrated because the top ranked results returned by the search engine failed to provide some or all of the information desired from the search. Often times, this frustration is followed by a subsequent attempt by the human user to electronically search the topic anew, usually using different language for the search query in the hope that the engine will return better results based on the new query language. This subsequent electronic search would be followed by another human review of the at least the top handful of search result pages and may have to be repeated multiple times until the desired information is obtained or the human gives up on their electronic search effort.

Thus, a system and method that more efficiently uncovers more of the universe of unique information relevant to a search query would be desirable.

More recently, electronic search engines have been coupled with artificial intelligence to produce potentially improved search queries and even, in some cases, to summarize the results returned by an electronic search engine. Usually, this artificial intelligence takes the form of large language models (LLM).

As is well-understood, use of large language models takes time, requires expensive processor resources (often graphical processing units (GPU)), generates a lot of heat and requires a lot of energy. Accordingly, use of LLMs to summarize the search results generated by an electronic search have been limited to a subset of the electronic objects returned. For example, the LLM may be instructed to summarize the top n (where n=1, 2, 3, . . . ) electronic objects returned by the search engine. This prior art approach is illustrated in FIG. 5 of the drawings.

The motivation to minimize processing time and costs by limiting the size of n is significant. However, as the size of n decreases, the risk of failing to include relevant information to the LLM for summarization increases. This “undersized selection” problem is very likely to be further exacerbated by the redundancy problem (noted above). Thus, there is a further need to provide a system and method for electronic search that minimizes the use of large language models while providing more fulsome summaries of more relevant information from electronic objects to minimize the time, monetary and environmental costs of using LLMs.

These as well as other needs in the art may be addressed by the systems and methods disclosed by the present disclosure as will be recognized by those of ordinary skill in the art after reviewing the present disclosure.

### SUMMARY OF THE DISCLOSURE

The present disclosure is directed to systems and methods of improving results of electronic search of preexisting electronic objects.

Embodiments described herein include systems for improving results of electronic search of preexisting electronic objects, wherein each of the preexisting electronic objects have been split into one or more data chunks and each of the one or more data chunks having been encoded into a first numeric vector representative of the data contained in that data chunk by a first embedder, each of the one or more data chunks and its representative first numeric vector stored in one or more respective data records in a knowledge base, the electronic search results being based on a query. The system comprises a second embedder that encodes the query into a second numeric vector representative of data associated with the query, wherein the second embedder works well with the first embedder, a search engine operably connected to the second embedder and to the knowledge base to retrieve a limited set of data records from the knowledge base based on similarity between the first numeric vector of the data record and the second numeric vector, a processor that (i) biases the first numeric vector, E, in each of the data records in the limited set of data records to a biased first numeric vector, E′, as a function of a distance, d, between the first numeric vector and the second numeric vector, E_{Q}, wherein E′=(1−c)*E+c*f(d)*E_{Q}, f(d)=1/(1+|d/D|^{s}), c is a number between 0 and 1, D is a number between about 3.0 and about 5.5, and s is a number between about 3.5 and about 57.2. The system further comprises an output device operably connected to the processor to receive the results of the electronic search as a function of each of the biased first numeric vectors in the limited set of data records.

In some embodiments, the processor may further (ii) cluster each of the data records in the limited set of data records into two or more result clusters based on the biased first numeric vector of that data record, and (iii) provide information representative of each of one or more of the two or more result clusters.

In further embodiments, the processor may further (iv) reduce a dimensionality of the biased first numeric vectors in the limited set of data records prior to clustering.

In yet further embodiments, the dimensionality reduction may be performed with UMAP.

In some embodiments, the system may further comprise a language model constructed to respond to the query based on the information representative of each of the one or more of the two or more result clusters.

In yet further embodiments, the system may further comprise a language model constructed to respond to the query based on the information representative of each of the one or more of the two or more result clusters.

In additional embodiments, the system may comprise a language model constructed to respond to the query based on the results of the electronic search as a function of each of the biased first numeric vectors in the limited set of data records.

In some embodiments, the search engine may use either cosine or distance similarity between the second numeric vector and the first numeric vector contained in each of the plurality of data records stored in the knowledge base to retrieve the limited set of data records.

Additionally, the first embedder and the second embedder may begin as the same model.

In some embodiments, the first and second embedders may be trained or tuned as a single model.

The method comprises improving results of electronic search of preexisting electronic objects, each of the preexisting electronic objects having been split into one or more data chunks and each of the one or more data chunks having been encoded into a first numeric vector representative of the data contained in that data chunk by a first embedder, each of the one or more data chunks and its representative first numeric vector stored in one or more respective data records in a knowledge base, the electronic search results being based on a query. In some embodiments, the method may (a) encode the query into a second numeric vector representative of the data associated with the query using a second embedder, wherein the second embedder works well with the first embedder, (b) retrieve a potentially relevant data record from the knowledge base based on similarity between the second numeric vector and the first numeric vector of the potentially relevant data record, (c) store the potentially relevant data record in a temporary data structure, repeat tasks (b) until (c) until the temporary data structure contains a limited set of data records, (e) bias, using a processor, the first numeric vector, E, in each of the potentially relevant data records in the limited set of data records to a biased first numeric vector, E′, as a function of a distance, d, between the first numeric vector and the second numeric vector, E_{Q}, wherein E′=(1−c)*E+c*f(d)*E_{Q}, f(d)=1/(1+|d/D|^{s}); c is a number between 0 and 1, D is a number between about 3.0 and about 5.5, and s is a number between about 3.5 and about 57.2, and (f) output search results selected from the limited set of data records based on the biased first numeric vectors.

In some embodiments, the method may further cluster each of the potentially relevant data records in the temporary data structure into two or more result clusters based on the biased first numeric vector of each potentially relevant data record, wherein outputting search results is further based on one or more of the two or more result clusters.

In additional embodiments, the method may reduce a dimensionality of the biased first numeric vector in the limited set of data records prior to clustering.

In yet further embodiments, the method may reduce the dimensionality of the biased first numeric vector performed using UMAP.

In some embodiments, the method may respond to the query using a language model constructed to respond to the query based on the information representative of each of the one or more of the two or more result clusters.

In additionally embodiments, the method may respond to the query using a language model constructed to respond to the query based on the limited set of data records.

In some embodiments, the method may train the second embedder alongside the first embedder.

These and other aspects of the disclosure will be further explained below.

### DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an overall system (100) for improving the results of an electronic search of preexisting electronic objects (as further described hereinbelow) and the interaction of the system 100 with one or more networks 10 and an electronic client 50.

FIG. 2 illustrates aspects of system 100, i.e., the clustering of search results and the use of the concepts represented by those clusters to support the creation of a summary of results generated by a large language model to be returned to the electronic client.

FIG. 3 is a flow diagram generally illustrating an approach to implementing the process associated with improving the results of electronic search of preexisting electronic objects.

FIG. 4 is a block diagram illustration of one potential system within which the inventive concepts disclosed in the present specification may be implemented.

FIG. 5 illustrates a prior art electronic search system.

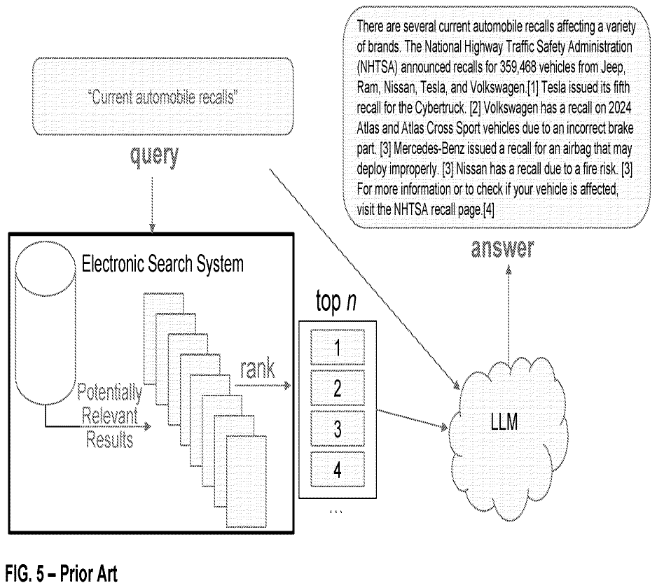

### DETAILED DESCRIPTION

This invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description is, therefore, not to be taken in a limiting sense.

In the following detailed description of embodiments of the inventive concepts, numerous specific details are set forth in order to provide a more thorough understanding of the inventive concepts. However, it will be apparent to those of ordinary skill in the art having the present specification before them that the inventive concepts explicitly set forth within the disclosure may be practiced without certain of the specific details provided. In other instances, certain features well-known by those in the relevant art may not be described to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. Those of ordinary skill in the art having the present specification before them will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including, but not limited to, each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

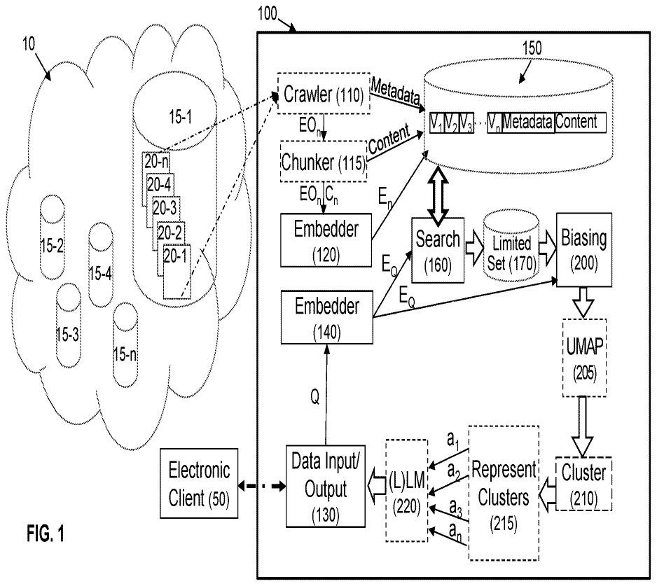

As illustrated in FIG. 1, the system 100 may comprise crawler 110, chunker 115, embedder 120, data input/output system 130, embedder 140, knowledge base 150, search engine 160, limited set 170, biasing engine 200, UMAP 205, clustering engine 210/215, and language model 220 (which may preferably be a large language model (LLM)).

Crawler 110 is a computer system that periodically (and generally independent of any user queries) searches and indexes electronically, the content of preexisting electronic objects 20 (also referred to herein as “objects”) contained on the one or more knowledge bases 15 (i.e., electronic objects 20-1, 20-2, 20-3, 20-4 . . . . 20-n contained on knowledge base 15-1) as hosted by systems accessible across one or more networks 10. In one example, network 10 may be the Internet and the knowledge bases 15 may be various document management systems accessible via the Internet. Alternatively, network 10 may be a closed network (such as the document management system of a single organization). Crawler 110 may collect metadata associated with the preexisting electronic objects in addition to the content of the preexisting electronic object, itself.

Chunker 115 is a computer system that splits the data gathered from an electronic object into smaller groupings or chunks (e.g., words, strings, pixels). Chunker 115 may be capable of looking at patterns within each electronic object received to determine more appropriate boundaries for the current chunk. For example, chunker 115 may use punctuation (e.g., periods, commas, colons) within text-based electronic object to divide up the document into sentence- or clause-based chunks. As would be understood by those of ordinary skill in the art having the present specification before them, each preexisting electronic object may be split into many chunks.

Embedder 120 is a computer system that represents non-numeric content, such as text and images, as a numerical value so that computer systems can more efficiently manipulate the content. These numerical values (often referred to as embeddings or Ex) are usually multi-dimensional vectors comprising V₁, V₂, V₃, . . . , Vₙ. Examples of embedders include image embedders and word or string/sentence embedders. Word or string/sentence embedders encode the meaning of a word (or a group of words) as a numerical value, in such a way that words/strings with similar meanings are expected to have similar values. Various models are known in the art. See, e.g., Wang, Liang et al., Multilingual E5 Text Embeddings: A Technical Report (February 2024), arXiv:2402.05672v1 [cs.CL]; Wang, Liang et al., Text Embeddings by Weakly-Supervised Contrastive Pre-training (February 2024), arXiv:2212.03533v2; Nils Reimers and Iryna Gurevych. 2019. Sentence-BERT: Sentence Embeddings using Siamese BERT-Networks. In Proceedings of the 2019 Conference on Empirical Methods in Natural Language Processing and the 9th International Joint Conference on Natural Language Processing (EMNLP-IJCNLP), pages 3982-3992, Hong Kong, China. Association for Computational Linguistics.

Embedder 120 may range in complexity from simple dictionary mapping all the way up to a large language model. Given the amount of data that may be fed into the embedder 120 by the chunker 115 over time, it is preferred that a computationally less-expensive approach be used to implement embedder 120. In particular, embedder 120 may be an off-the-shelf embedding model or perhaps a very generally-tuned model. For instance, a few text embedding models that may be used to implement embedder 120 may include intfloat/multilingual-e5-small (https://huggingface.co/intfloat/multilingual-e5-small); sentence-transformers/paraphrase-multilingual-MiniLM-L12-v2 (https://huggingface.co/sentence-transformers/paraphrase-multilingual-MiniLM-L12-v2); and intfloat/e5-small-v2 (https://huggingface.co/intfloat/e5-small-v2). As embedder 120 may also be used to create embeddings for images, music, and other-non-text content, alternative embedding models (e.g., image embedders, music embedders) may also be included in embedder 120, along with logic to assess the incoming non-numeric content toward selecting the appropriate type of embedder for the data type presented. It is further contemplated that embedder 120 does not have to be tuned for any particular content, user or use case.

Knowledge base 150 is a data store for each chunk for the electronic objects 20 crawled by crawler 110. As illustrated in FIG. 1, the data record for each chunk stored in knowledge base 150 preferably contains the metadata for the associated electronic object 20-n (as retrieved by crawler 110); the raw content associated with that chunk (e.g., text, image); and the embedding, Eₙ (depicted as a vector having numerical components V₁, V₂ . . . Vₙ). While FIG. 1 illustrates that the metadata may be provided to the knowledge base 150 by the crawler 110, it is contemplated that the metadata may be provided to the knowledge base 150 by a different subsystem. As with any standard database, the data records contained in knowledge base 150 are preferably randomly and independently accessible.

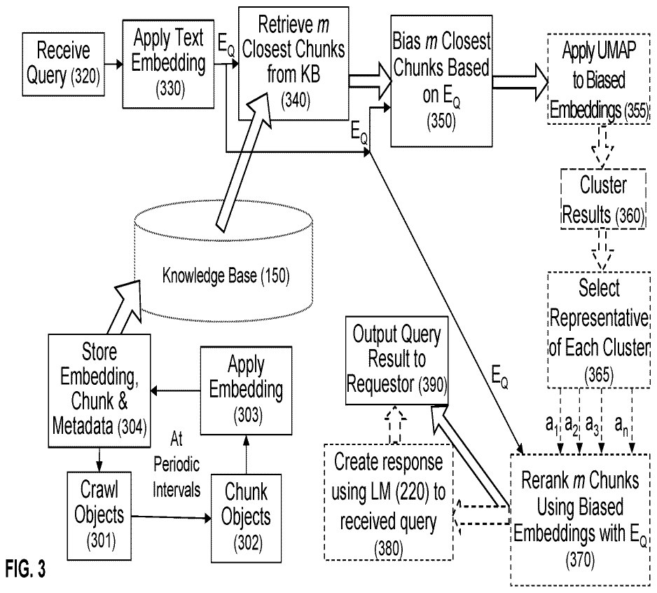

As illustrated in the lower left hand corner of the flow diagram of FIG. 3, crawler 110, chunker 115, and embedder 120 (from FIG. 1) operate at periodic intervals (i.e., independent of the receipt of any queries) to crawl preexisting electronic objects (301) located within the one or more networks 10; chunk the preexisting electronic objects (302) returned by the crawler 110; apply an embedding (303) to each chunk using embedder 120; and then store the embedding, chunk, and metadata (304) into the knowledge base (150).

FIG. 3 is a flow diagram generally illustrating an approach to implementing the process associated with improving the results of electronic search of preexisting electronic objects. The tasks described in the foregoing paragraph represent the common approach to obtaining preexisting electronic objects for subsequent search operations. The flow diagram of FIG. 3 also describes the novel aspects of system 100. In particular, operations 330-380 set forth in the flow diagram of FIG. 3 are triggered by the receipt of a query (320) via data input/output system 130 (FIG. 1) from an electronic client 50. As such those operations will be described after the following description of the components involved following the receipt of a query.

Embedder 140 (FIG. 1) is a computer system that represents non-numeric content, such as text and image, as a numerical value so that computer systems can more efficiently manipulate the content. Normally, the architecture of the models for embedders 120 and 140 is the same—with embedder 120 and embedder 140 differing only by values of their weights (i.e., parameters). For instance, a small embedder model contains typically on order of 100M-1B parameters.

It is contemplated that embedder 140 and embedder 120 will be tuned in accordance with one of the following approaches:
A. embedder 120 and embedder 140 are set to be identical (i.e., they always have the same weights) and they are trained or tuned as a single model;
B. embedder 120 and embedder 140 begin identical, but then are trained together, allowing their parameters to diverge;
C. one of embedder 120 and embedder 140 was previously tuned, and then the two embedders are trained together; or
D. substitute values for the parameters of embedder 120 and embedder 140 and then train them together.

When embedding models are tuned together it is generally referred to as combining the embedders 120 and 140 into a “dual encoder” of a “bi-encoder.” As a result of any of the foregoing approaches, the embeddings produced by embedder 140 will necessarily work well together with the embeddings produced by embedder 120.

Once the sub-system of embedders 120 and 140 is tuned to a domain or type of query, both embedders may be frozen. It may be desirable to tune embedder 140 (also known as the “query encoder”) to improve the performance of the system on specific data. These deviations may be due to the fact that either (A) the queries input into system 100 differ from most, if not all, of the chunks fed through embedder 120, or (B) embedder 140 may be tuned to operate on specific types of queries. In this regard, it is contemplated that within system 100 the query encoder (embedder 140) may be switched at any time for any user or use case (e.g., to allow for a particular domain or type of query), but the text encoder (embedder 120) will stay static to avoid the need to re-encode all of the embeddings, Eₙ, previously stored in the knowledge base 150.

Embedders 120 and 140 may also have different architectures, but then be additionally trained (or subjected to heavy tuning) to bring embedders 120 and 140 together or bring one of them to the other (which in this scenario would be frozen). In one embodiment with two different embedder architectures, two language models (LM) may be used, where the language model used for embedder 140 (i.e., the query embedder) is smaller than the language model used for embedder 120 (i.e., the text embedder) to handle a large number of queries (which may be due to either a large user count or a large number of queries per user). When the volume of queries expected to be input into embedder 140 by data input/output system 130 is orders of magnitude smaller than the number of chunks of preexisting electronic objects fed into embedder 120 by chunker 115, embedder 140 may be a computationally more-expensive encoding approach than the model used for embedder 120. See, e.g., Campos, Daniel et al., Quick Dense Retrievers Consume KALE: Post Training Kullback Leibler Alignment of Embeddings for Asymmetrical dual encoders, arXiv:2304.01016 [cs.CL], which is hereby incorporated by reference in its entirety. The opposite scenario may also be considered according to some embodiments, (i.e., fewer queries, but a desire for improved quality (and decreased speed)), in which case a larger language model would be used for the text embedder (120) than the language model used for the query embedder (140). Adoption of one approach or the other may reflect a compromise between quality and latency concerns. There may be many other cases where asymmetric encoders make sense, including but not limited to the situation where embedder 120 operates solely to encode images while embedder 140 still encodes textual queries.

Still, in the more common construction contemplated, the structure of the encoder (embedder) models 120 and 140 are the same, but their weights may be different. In such an approach, according to some embodiments, the computational expense of running embedder 120 and embedder 140 may be the same. The advantage in having embedders 120 and 140 differ lies in the recognition that the query differs from the electronic objects (or the chunks created therefrom) and the flexibility to change embedder 140 at any time. For example, it may be preferable to further tune embedder 140 for user queries. This query tuning of embedder 140 may be based on information regarding the use case or user, including, for example, particular associated jargon (e.g., doctor/medicine, lawyer/legal, scientist/particular field of study), historical information regarding prior queries input by the user, previous search results delivered to the user, and/or an analysis of language used in knowledge bases associated with the user.

Embedder 140 receives a query, Q, from data input/output system 130 and generates an embedding, E_{Q}. Embedding E_{Q} is preferably a multi-dimensional vector. As illustrated in FIGS. 1 and 3, E_{Q} is used by search engine 160 to retrieve a limited set of chunks (170) (e.g., E₁, E₂, E₃, . . . Eₘ) from knowledge base 150 that are similar to the query embedding (with similarity being defined either by cosine between the vectors or by distance (length of the difference between the vectors)). In particular, search engine 160 uses either cosine or distance similarity between the query embeddings (produced by query embedder 140) and the text embeddings (produced by text embedder 120) and stored in the knowledge base 150 to retrieve potentially relevant embeddings.

The number of embeddings, m, retrieved by the search engine 160 may range from a few, to 100, 1000, or even as many as 10,000. The primary criterion for determining the size of the number m is that it not be so small that the search engine 160 fails to retrieve data records important for answering the query. Here, particular consideration may be given to the design of search 160 (i.e., retrieve m closest chunks from KB (340)) as an imperfect search by simple similarity, which often picks up many unhelpful data records as well as fully or partially redundant data. On the other hand, the number of embeddings, m, retrieved for the limited set 170 may be constrained to fewer results to minimize excess computational overhead particularly in the subsequent task of creating a response to received query using an LM (380). The increase in computational overhead in the biasing task and post-biasing operations (i.e., dimensional reduction (UMAP 205) and optional clustering (210/215) may also be a factor in setting the maximum number of retrieved embeddings, m, lower.

The maximum number of embeddings retrieved by the search may be constant, may be set by the user, or may be varied by system 100 based on periodic analysis of the performance of the system 100, including, among other potential conditions, processing time, idle time, energy used, query processing backlogs, and search performance against test data.

Biasing engine 200 biases each of the m text embeddings in the limited set 170 based on the query embedding. Biasing refers to recalculating the values of the retrieved text embeddings in response to the query embedding, each of these embeddings are multi-dimensional vectors that have directionality. Focusing for the moment on text searching—which is the more common use case—biasing draws text embeddings (a vector value) that are directionally similar to the query embedding (a vector value) toward the query embedding and those text embeddings that are directionally different from the query embedding are diverted further away from the direction of the query embedding.

There are two preferred approaches to accomplish this biasing: (1) distance-based and (2) exponent-based. In the distance-based biasing approach, the biasing engine 200 biases the retrieved embeddings, Eₙ, for each of the retrieved embeddings (in limited set 170) based on the following relationships:

$${E}_{{n}^{′}} = {( 1 - c )}^{*} {E}_{n} + {c}^{*} {f ( d )}^{*} {E}_{Q}$$

Where f(d)=1/(1+|d/D|^{s}); d=|Eₙ−E_{Q}|; and c (mixing), D (scale) and s (exponent) are coefficients. The exponent-based biasing approach is the same as the distance-based approach with f(d)=exp[−|d/D|^{s}].

Two other functions which may offer additional approaches to biasing, according to some embodiments, are: (3) cosine and (4) dot product. The dot product relationship currently under consideration is:

$${E}_{{n}^{′}} = {( 1 - c )}^{*} {E}_{n} + {c}^{*} {p}^{*} {E}_{Q} , where p = ( {E}_{n} {E}_{Q} )$$

which may be more generically considered as:

$${E}_{{n}^{′}} = {( 1 - c )}^{*} {E}_{n} + {c}^{*} \vert p / D \vert {s}^{*} {E}_{Q} , where p = ( {E}_{n} {E}_{Q} ) .$$

Evaluation of the two preferred biasing approaches (with various potential coefficient values) were conducted using the publicly available Multilingual-E5 Text Embeddings set found at https://huggingface.co/intfloat/multilingual-e5-small; see also Wang et al., Multilingual E5 Text Embeddings: A Technical Report, arXiv:2402.05672 [cs.CL]. These evaluations showed that even where all of the coefficients (c, D and s) are set to one, there is still a performance improvement observed (as shown in the following Spearman correlations) (Table 1):

| | | Biased | Biased |
|---|---|---|---|
| | | using | using |
| | | Distance- | exponent- |
| | No | based | based |
| Subset | biasing | approach | approach |
| Training | 0.106 | 0.137 | 0.138 |
| Validation | 0.085 | 0.147 | 0.147 |
| Reannotated | 0.150 | 0.220 | 0.222 |

Further analyses of the impact on biasing of setting the coefficients were conducted using Conditional Semantic Textual Similarity (“C-STS”). Based on those analyses, it can further be said that the maximum Spearman correlations reported above were achieved using distance-based biasing, as follows (Table 2):

| c (MIX) | D (scale) | s (exponent) |
|---|---|---|
| 0.70 | ~3.2 to ~4.2 | ~3.5 to ~9.2 |
| 0.95 | ~3.8 to ~5.5 | ~4.2 to ~19.2 |
| 0.60 | ~3.0 to 3.4 | ~12.2 to 57.2 |

Aside from requiring coefficients to be constrained as follows: D>0; s>0; 0<c<1, their values may depend (within the foregoing constraints) on a domain of documents and on a type of a query. Given the design of system 100, there is flexibility to switch coefficient values, according to some embodiments, between several choices from search to search and even from moment to moment. Moreover, as reflected in the data in Table 2 above there are wide enough coefficient ranges for which improvement in correlations with human-annotated data is shown to be flexible.

After the text embeddings in the limited set 170 are biased (task 350), they may optionally be subjected to dimensionality reduction and/or to clustering in order to address the redundancy problem found in prior art. In particular, as illustrated in FIG. 3, in a preferred embodiment the biased limited set of search results may be further processed at run-time to the m samples by: (a) applying UMAP (using UMAP engine 205, FIG. 1) to the biased embeddings (355) to reduce the dimensionality of the biased embeddings; (b) clustering the results (360); and (c) selecting a representative of each cluster (365). Clustering results (360) and selecting representative clusters (365) may be performed even where UMAP is not applied to biased embeddings (355). It is less likely, but possible to apply UMAP while bypassing the clustering tasks (360, 365) because the purpose of dimensionality reduction is to improve the quality of the clustering and make the clustering tasks more computationally efficient (with the understanding that the combined process of dimensionality reduction followed by clustering may overall not be more computational efficient). According to some embodiments, the clustering tasks (360, 365) may extract less duplicative and less trivially related (but still interesting) electronic data objects from the limited set, toward finding appropriate representatives for input into the (L)LM 220. In other words, applying the optional clustering may be more likely to provide incremental data that is a greater distance from the query (while still requiring a strong connection to the query).

As would also be understood by those of ordinary skill in the art having the present specification before them, there are alternate dimensionality reduction schemes that may be reasonably used in place of UMAP. UMAP is a preferred dimensionality reduction scheme in system 100 because it emphasizes “connectivities” within the dataset used to train it. For a further explanation of these connectivites see, e.g., UMAP: Uniform Manifold Approximation and Projection for Dimension Reduction, arXiv:1802.03426 [stat.ML]; https://umap-learn.readthedocs.io/en/latest/how_umap_works.html, is hereby incorporated by reference in its entirety. In experiments involving typical news-like, media tweet-like or document-like texts and k-means clustering, applying the following parameters to UMAP provided acceptable results: 10-20 number of components, 10 neighbors and 0-10 minimal distance. In some embodiments, using reasonable parameters that UMAP followed by clustering, may give better clustering results than clustering alone. Of course, other settings may work equally well or better depending upon a variety of variables, including but not limited to the data in knowledge base 150.

While other dimensionality reduction techniques may also improve the quality of the subsequent clustering operations, the UMAP operation (requiring both training and subsequent application), itself, requires processor power and additional time and may, in some instance, undesirably skew the subsequent clustering of the reduced embeddings due to the reduction in dimensionality. Thus, as would be understood by those of ordinary skill in the art having the present specification before them should comprehend, the application of UMAP to the embeddings involves consideration of trade-offs that are likely impacted by the scope of the query and the scope of the closest data retrieved from knowledge base 150 in response to the query. One approach to moderating the trade-offs in favor of applying UMAP (or other dimensionality reduction scheme) includes limiting the application of dimensionality reduction to only a subset of the biased m closest chunks (e.g., the top n chunks, where n<m).

As illustrated in FIG. 3, the task of clustering the results 360 may be performed on the biased embeddings associated with the set of m chunks (or on the UMAP-reduced versions of those m embeddings). Various clustering techniques may be chosen to conduct this task. The preferred clustering technique may depend upon the embedding techniques selected for the embedder. For example, the preferred clustering algorithm may include, among other potential approaches: K-means; Agglomerative; HDBSCAN. The most preferred clustering algorithm due to its speed and good performance would be K-means.

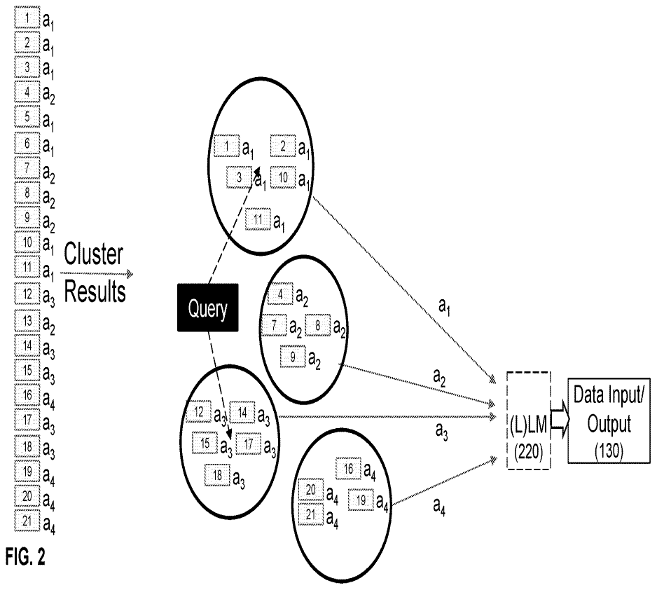

FIG. 2 provides a high-level illustration of the effect of clustering the results and presenting representative chunks associated with each cluster to a language model, which may be a large language model (“(L)LM”) to create a response to the received query. This response may comprise a summary of the search or it could be the result of prompting the language model to answer the received query based on the subset of m biased chunks established in task 370 (or even the set generated as a result of task 350).

As is generally understood, clustering is the task of grouping objects such that all of the objects in a particular grouping are more similar to one another than they are to the other groupings. The best cluster(s) are selected by locating the closest cluster centroids to the query. The best samples within a cluster are located by finding k closest samples to that cluster centroid. According to some embodiments, one may keep sampling the next best cluster until n number of samples are retrieved or there are no more clusters remaining. Both n and k can be adjusted depending on the task. The number of clusters created by the system requires a trade-off between average distance of a cluster (which may be measured from the centroid of the cluster) to the query embedding (here the lower the distance is closer to the context of query) and the distance between the clusters (again, preferably measured between centroids) (here the greater the distance the better). It is contemplated that this clustering task may result in too many clusters being formed or each cluster containing too many objects. For such cases, maximum dependency and cluster sizes may be pre-established to constrain the clustering operation.

FIG. 2 illustrates that the embeddings of twenty-one electronic chunks might be clustered into four groups (a₁, a₂, a₃, a₄). In particular
group a₁ comprises chunks 1, 2, 3, 10 and 11;
group a₂ comprises chunks 4, 7, 8, and 9;
group a₃ comprises chunks 12, 14, 15, 17, and 18; and
group a₄ comprises chunks 16, 19, 20 and 21.
   FIG. 2 further illustrates that the concept, an, around which each grouping of chunks has been clustered may form the primary input to an LM 220. LM 220 may be a large language model (LLM) that uses the concepts (aₙ), associated chunks and their metadata to generate a response to the received query that is returned to the electronic client 50 via data input/output system 130. This response may take the form of a summary of the search results. FIG. 2 further illustrates a distance between the value of the center (i.e., centroid) of two clusters, a₁ and a₃, and the value of the query embedding. The shorter the distance the closer the centroid of the cluster to the query, which may be used in determining the relative similarity of each cluster to the query.

As illustrated in FIG. 3, the biased embeddings associated with the set of m chunks either directly after the biasing task (350) or after optional dimension reduction (355) and optional clustering (360/365) may be optionally reranked against the query embedding. As a result of the retrieval-biasing-reranking process (FIG. 3, reference numbers 340-350-360), the top ranked results (selected from amongst the m chunks retrieved from the knowledge base (340)) provide a deeper search result than would generally be provided by a standard search, thus, addressing the undersized selection problem of the prior art.

After the limited set of biased (and potentially clustered and optionally reranked) search results have been produced they can either be output directly to the requestor, or, as illustrated in FIG. 3, a language model (preferably a large language model (LLM)) may be used to produce a response to the original query (see task 380). This response may comprise a summary of the search results.

### Computing Environment

It should also be noted that the various logic and functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Aspects of the methods and systems described herein, such as the logic or machine learning models, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

Aspects of the methods and systems disclosed herein may be embodied and/or executed by the logic of the processes described herein, which may also be embodied in the form of software instructions and/or firmware that may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors, for example. Each and every one of the foregoing examples may be referred to generally as being a processor.

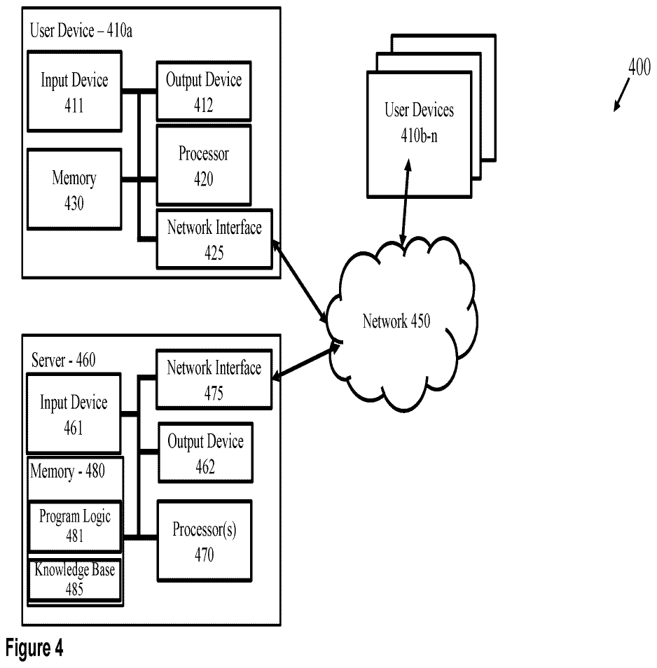

Aspects of the methods and systems described herein may also be implemented on an illustrative system 400, depicted in association with FIG. 4. In particular, system 400 may comprise a user devices 410a-n, server 460, and network 450.

The user device 410 of the system 400 may include various components including, but not limited to, one or more input devices 411, one or more output devices 412, one or more processors 420, a network interface device 425 capable of interfacing with the network 450, one or more non-transitory memories 430 storing processor executable code and/or software application(s), for example including, a web browser capable of accessing a website and/or communicating information and/or data over the network, and/or the like. The memory 430 may also store an application (not shown) that, when executed by the processor 420 causes the user device 410 to provide the functionality of the various systems and methods described the present specification, as would be understood by those of ordinary skill in the art having the present specification, drawings, and claims before them.

The input device 411 may be capable of receiving information input from the user and/or processor 420, and transmitting such information to other components of the user device 410 and/or the network 450. The input device 411 may include, but are not limited to, implementation as a keyboard, touchscreen, mouse, trackball, microphone, remote control, and combinations thereof, for example.

The output device 412 may be capable of outputting information in a form perceivable by the user and/or processor 420. For example, implementations of the output device 412 may include, but are not limited to, a computer monitor, a screen, a touchscreen, an audio speaker, a website, and combinations thereof, for example. It is to be understood that in some exemplary embodiments, the input device 411 and the output device 412 may be implemented as a single device, such as, for example, a computer touchscreen. It is to be further understood that as used herein the term “user” is not limited to a human being, and may comprise, a computer, a server, a website, a processor, a network interface, a user terminal, and combinations thereof, for example.

The server 460 of the system 400 may include various components including, but not limited to, one or more input devices 461, one or more output devices 462, one or more processors 470, a network interface device 475 capable of interfacing with the network 450, and one or more non-transitory memories 480 for storing data structures/tables (including those of knowledge base 485) that may be used by the system 400 and particularly server 460 to perform the functions and procedures set forth herein. The memory 480 may also store an application/program store 481 that, when executed by the processor 470 causes the server 460 to provide the functionality of the systems and methods disclosed in the present application.

As shown in FIG. 4, the server 460 may include a single processor (or multiple processors) 470 working together or independently to execute the program logic 481 stored in the memory 480 as described herein. It is to be understood, that in embodiments using more than one processor, the processors may be located remotely from one another, located in the same location, or comprising a unitary multi-core processor. The processors 470 may be capable of reading and/or executing processor executable code and/or capable of creating, manipulating, retrieving, altering, and/or storing data structures and data tables (including those of knowledge base 485) into the memory 480.

Exemplary embodiments of the processor 470 may include, but are not limited to, a digital signal processor (DSP), a central processing unit (CPU), a field programmable gate array (FPGA), a microprocessor, a multi-core processor, combinations, thereof, and/or the like, for example. The processor 470 may be capable of communicating with the memory 480 via a path (e.g., data bus). The processor 470 may be capable of communicating with the input device 461 and/or the output device 462.

The input device 461 of the server 460 may be capable of receiving information input from the user and/or processor 470, and transmitting such information to other components of the server 460 and/or the network 450. The input device 461 may include, but are not limited to, implementation as a keyboard, touchscreen, mouse, trackball, microphone, remote control, and/or the like and combinations thereof, for example. The input device 461 may be located in the same physical location as the processor 470, or located remotely and/or partially or completely network-based.

The output device 462 of the server 460 may be capable of outputting information in a form perceivable by the user and/or processor 470. For example, implementations of the output device 462 may include, but are not limited to, a computer monitor, a screen, a touchscreen, an audio speaker, a website, a computer, and/or the like and combinations thereof, for example. The output device 462 may be located with the processor 470, or located remotely and/or partially or completely network-based.

The memory 480 stores applications or program logic 481 as well as data structures (including those of knowledge base 485) that may be used by the system 400 and particularly server 460. The memory 480 may be implemented as a conventional non-transitory memory, such as for example, random access memory (RAM), CD-ROM, a hard drive, a solid state drive, a flash drive, a memory card, a DVD-ROM, a disk, an optical drive, combinations thereof, and/or the like, for example. In some embodiments, the memory 480 may be located in the same physical location as the server 460, and/or one or more memory 480 may be located remotely from the server 460. For example, the memory 480 may be located remotely from the server 460 and communicate with the processor 470 via the network 450. Additionally, when more than one memory 480 is used, a first memory 480a may be located in the same physical location as the processor 470, and additional memory 480n may be located in a location physically remote from the processor 470. Additionally, the memory 480 may be implemented as a “cloud” non-transitory computer readable storage memory (i.e., one or more memory 480 may be partially or completely based on or accessed using the network 450).

Each element of the server 460 may be partially or completely network-based or cloud-based, and may or may not be located in a single physical location. As used herein, the terms “network-based,” “cloud-based,” and any variations thereof, are intended to include the provision of configurable computational resources on demand via interfacing with a computer and/or computer network, with software and/or data at least partially located on a computer and/or computer network. In other words, the server 460 may or may not be located in a single physical location. Additionally, multiple servers 460 may or may not necessarily be located in a single physical location.

Knowledge base 485 may comprise one or more data structures and/or data tables stored on non-transitory computer readable storage memory 480 accessible by the processor 470 of the server 460. The knowledge base 485 can be a relational database or a non-relational database. Examples of such databases include, but are not limited to: DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The knowledge base 485 can be centralized or distributed across multiple systems.

While particular embodiments of the present invention have been shown and described, it should be noted that changes and modifications may be made without departing from the presently disclosed inventive concepts in its broader aspects and, therefore, the aim in the appended claims is to cover all such changes and modifications as fall within the true spirit and scope of this invention.

What is claimed is:

1. A system for improving results of electronic search of preexisting electronic objects, each of the preexisting electronic objects having been split into one or more data chunks and each of the one or more data chunks having been encoded into a first numeric vector representative of the data contained in that data chunk by a first embedder, each of the one or more data chunks and its representative first numeric vector stored in one or more respective data records in a knowledge base, the electronic search results being based on a query, the system comprising:
a second embedder that encodes the query into a second numeric vector representative of data associated with the query, wherein the second embedder works well with the first embedder;
a search engine operably connected to the second embedder and to the knowledge base to retrieve a limited set of data records from the knowledge base based on similarity between the first numeric vector of the data record and the second numeric vector;
a processor that (i) biases the first numeric vector, E, in each of the data records in the limited set of data records to a biased first numeric vector, E′, as a function of a distance, d, between the first numeric vector and the second numeric vector, E_{Q}, wherein E′=(1−c)*E+c*f(d)*E_{Q}, f(d)=1/(1+|d/D|^{s}); c is a number between 0 and 1, D is a number between about 3.0 and about 5.5, and s is a number between about 3.5 and about 57.2; and
an output device operably connected to the processor to receive the results of the electronic search as a function of each of the biased first numeric vectors in the limited set of data records.

2. The system according to claim 1 wherein the processor further (ii) clusters each of the data records in the limited set of data records into two or more result clusters based on the biased first numeric vector of that data record, and (iii) provides information representative of each of one or more of the two or more result clusters.

3. The system according to claim 2 wherein the processor further (iv) reduces a dimensionality of the biased first numeric vectors in the limited set of data records prior to clustering.

4. The system according to claim 3 wherein the dimensionality reduction is performed with UMAP.

5. The system according to claim 4 further comprising a language model constructed to respond to the query based on the information representative of each of the one or more of the two or more result clusters.

6. The system according to claim 2 further comprising a language model constructed to respond to the query based on the information representative of each of the one or more of the two or more result clusters.

7. The system according to claim 1 further comprising a language model constructed to respond to the query based on the results of the electronic search as a function of each of the biased first numeric vectors in the limited set of data records.

8. The system according to claim 1 wherein the search engine uses either cosine or distance similarity between the second numeric vector and the first numeric vector contained in each of the plurality of data records stored in the knowledge base to retrieve the limited set of data records.

9. The system according to claim 1 wherein the first embedder and the second embedder begin as the same model.

10. The system according to claim 9 wherein the first and second embedders are trained or tuned as a single model.

11. A method for improving results of electronic search of preexisting electronic objects, each of the preexisting electronic objects having been split into one or more data chunks and each of the one or more data chunks having been encoded into a first numeric vector representative of the data contained in that data chunk by a first embedder, each of the one or more data chunks and its representative first numeric vector stored in one or more respective data records in a knowledge base, the electronic search results being based on a query, the method comprising:
(a) encoding the query into a second numeric vector representative of the data associated with the query using a second embedder, wherein the second embedder works well with the first embedder;
(b) retrieving a potentially relevant data record from the knowledge base based on similarity between the second numeric vector and the first numeric vector of the potentially relevant data record;
(c) storing the potentially relevant data record in a temporary data structure;
(d) repeating tasks (b) until (c) until the temporary data structure contains a limited set of data records;
(e) biasing, using a processor, the first numeric vector, E, in each of the potentially relevant data records in the limited set of data records to a biased first numeric vector, E′, as a function of a distance, d, between the first numeric vector and the second numeric vector, E_{Q}, wherein E′=(1−c)*E+c*f(d)*E_{Q}, f(d)=1/(1+|d/D|^{s}); c is a number between 0 and 1, D is a number between about 3.0 and about 5.5, and s is a number between about 3.5 and about 57.2; and
(f) outputting search results selected from the limited set of data records based on the biased first numeric vectors.

12. The method according to claim 11 further comprising clustering each of the potentially relevant data records in the temporary data structure into two or more result clusters based on the biased first numeric vector of each potentially relevant data record, wherein outputting search results is further based on one or more of the two or more result clusters.

13. The method according to claim 12 further comprising reducing a dimensionality of the biased first numeric vector in the limited set of data records prior to clustering.

14. The method according to claim 13 wherein reducing the dimensionality of the biased first numeric vector is performed using UMAP.

15. The method according to claim 14 further comprising responding to the query using a language model constructed to respond to the query based on the information representative of each of the one or more of the two or more result clusters.

16. The method according to claim 11 further comprising responding to the query using a language model constructed to respond to the query based on the limited set of data records.

17. The method according to claim 11 further comprising training the second embedder alongside the first embedder.
